(19) United States
(12) Patent Application Publication
(10) Pub. No.: US 2004/0016740 A1
(43) Pub. Date: Jan. 29, 2004

(54) Method and device for heating a surface

(76) Inventor: Corey E. McDonald, Olathe, KS (US)

Correspondence Address: SHOOK, HARDY & BACON LLP, 2555 GRAND BLVD, KANSAS CITY,, MO, 64108, US

(21) Appl. No.: 10/205,336

(22) Filed: Jul. 24, 2002

(51) Int. Cl. H05B 3/00

(52) U.S. Cl. 219/213; 219/544

(57) ABSTRACT

A device for melting snow and/or ice on a surface is provided. The device includes a heat coil that is adapted to allow a fluid to pass therethrough, a pump and a solar power source. The heat coil has an upper portion positioned at first distance from surface, and a lower portion that is positioned at a second distance from surface and underneath the ground. The pump coupled between the solar power source and the heat coil. The solar power source provides energy to the pump to move the fluid between the lower and upper portions of the heat coil. The fluid gains heat from the ground as it moves through the lower portion of the heat coil and uses that heat to raise the temperature of the surface to melt snow and/or ice that comes into contact therewith.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

The present invention relates to a method and device for heating a surface. In particular, the present invention relates to a method and device for melting ice and/or snow that is on a surface.

During the winter months, it is common for ice and snow to accumulate on roads, driveways, parking lots, sidewalks and other types of surfaces. In order to maintain a safe environment for driving and walking, it is necessary to remove ice and snow buildup from such surfaces. Removing snow and ice from these surfaces has traditionally been accomplished by plowing or shoveling, which usually requires a significant amount of time, manpower and equipment. The cost of implementing such resources is relatively high, especially in the case of high-volume snow removal. In addition, repeated plowing and shoveling causes the road to deteriorate at an accelerated rate, thereby increasing the cost of road maintenance. In light of the relatively high costs of these traditional methods of ice and snow removal, other alternatives have been developed.

For instance, certain chemicals such as magnesium chloride (MgCl₂), sodium chloride (NaCl), calcium chloride (CaCl₂) and other deicers have been used to reduce the accumulation of snow and ice on these surfaces. The chemicals are applied to the surface and dissolve as they melt the snow and ice on the surface. However, the use of chemical deicers also has a number of drawbacks. Specifically, the dissolved chemicals that are carried away by the melted snow and ice eventually travel along the ground surface or leech into the ground, thus affecting the water quality of the surface water and groundwater. Furthermore, the deicing chemicals break down and deteriorate the surfaces thereby reducing the life of the surface.

In an effort to reduce the negative impacts on the environment and reduce the amount of time and manpower used in traditional snow and ice removal methods, another type of removal system was developed. This particular removal system includes a grid that is positioned underneath the surface, a pipe positioned underneath the grid which is filled with water, and a boiler to heat the water in the pipe. The heat of the water within the pipe is then transferred to the grid. The heat in the grid is transferred to the surface, which in turn melts snow or ice that has accumulated on the surface. This device also suffers from various drawbacks in that it is relatively expensive to operate due to the large amount of energy that is required to use the boiler to heat the water in the pipe.

Accordingly, there remains a need for a method and device that will cost-efficiently reduce the amount of time, cost and manpower required to remove ice and snow from a surface without significantly affecting the environment. The present invention fills these needs as well as various other needs.

### BRIEF SUMMARY OF THE INVENTION

In order to overcome the above-stated problems and limitations, and to achieve the noted objects, there is provided a heating device that may be inexpensively used to melt snow and/or ice accumulation on a surface.

In general, a device is provided which includes a heat coil that is adapted to allow a fluid to pass therethrough, a pump and a solar power source. The heat coil has an upper portion that is positioned at a first distance below the surface, and a lower portion that is positioned at a second distance below the surface and underneath the ground. The second distance being greater than the first distance. The pump is coupled between the solar power source and the heat coil. The solar power source provides energy to the pump to move the fluid between the lower and upper portions of the heat coil. The fluid gains heat from the ground as it moves through the lower portion of the heat coil and uses that heat to raise the temperature of the surface as the fluid moves through the upper portion of the heat coil. Thus, the resulting increase in temperature melts snow and/or ice that comes into contact with the heated surface.

Additionally, the device may further include a control panel and a power storage unit. The control panel is coupled between the pump and solar power source and operates to control the amount of energy transferred to the pump. The power storage unit is coupled with the control panel and is used to store energy collected by the solar power source. The fluid in the device may be mixed with antifreeze to prevent the fluid from freezing within the heat coil. Furthermore, the lower portion of the heat coil may be buried three to six feet underneath the ground.

A method for heating the surface includes providing a heat coil that allows a fluid to pass therethrough, a pump and a solar power source. The heat coil includes an upper portion positioned at a first distance below the surface, and a lower portion positioned at a second distance below the surface and underneath the ground. The second distance being greater than the first distance. The method includes heating the fluid in the lower portion of the heat coil, powering the pump with the solar power source, and moving the fluid from the lower portion to the upper portion using the pump. The heat in the fluid is then transferred to the surface to melt the snow and/or ice thereon. The method further includes providing a power storage unit and storing the energy collected by the solar power source in the power storage unit. This method further provides for controlling the movement of the fluid between the lower and upper portions of the heat coil. In addition, the lower portion of the heat coil may be positioned about three to six feet underneath the ground.

One alternative embodiment of the present invention provides for a device that includes a heating element and a solar power source. The heating element is positioned below the surface and the solar power source is coupled to the heating element. The solar power source provides power to the heating element to increase the temperature of the heating element, and the heat from the heating element is used to melt the snow and/or ice on the surface. The device may further include a power storage unit and a control panel. The power storage unit is coupled with the control panel to store energy collected by the solar power source. The control panel is coupled between the solar power source and the heating element.

One alternative method for heating a surface includes providing a solar power source and a heating element positioned at a distance below the surface, transferring energy from the solar power source to the heating element. The heat from the heating element is used to melt the snow and/or ice accumulation on the surface. The method may further provide for a power storage unit that stores the energy collected by the solar power source. In addition, the method may include controlling the amount of energy transferred to the heating element.

Further objects, features, and advantages of the present invention over the prior art will become apparent from the detailed description of the drawings which follows, when considered with the attached figures.

### BRIEF DESCRIPTION OF THE SEVERAL VIEWS OF THE DRAWINGS

In the accompanying drawings which form a part of the specification and are to be read in conjunction therewith and in which like reference numerals are employed to indicate like parts in the various views:

FIG. 1 is a schematic plan view with a portion of a surface broken away to show a heating device according to the present invention, a portion of the heating device being shown in broken lines;

FIG. 2 is a perspective view with a portion of the surface and the ground broken away to show a heat coil and pump of the heating device;

FIG. 3 is a schematic plan view with a portion of the surface broken away to show an alternative embodiment of the present invention; and

FIG. 4 is a perspective view of the alternative embodiment shown in FIG. 3 having a portion of the surface and the ground broken away to show a heating element of the alternative heating device.

### DETAILED DESCRIPTION OF THE INVENTION

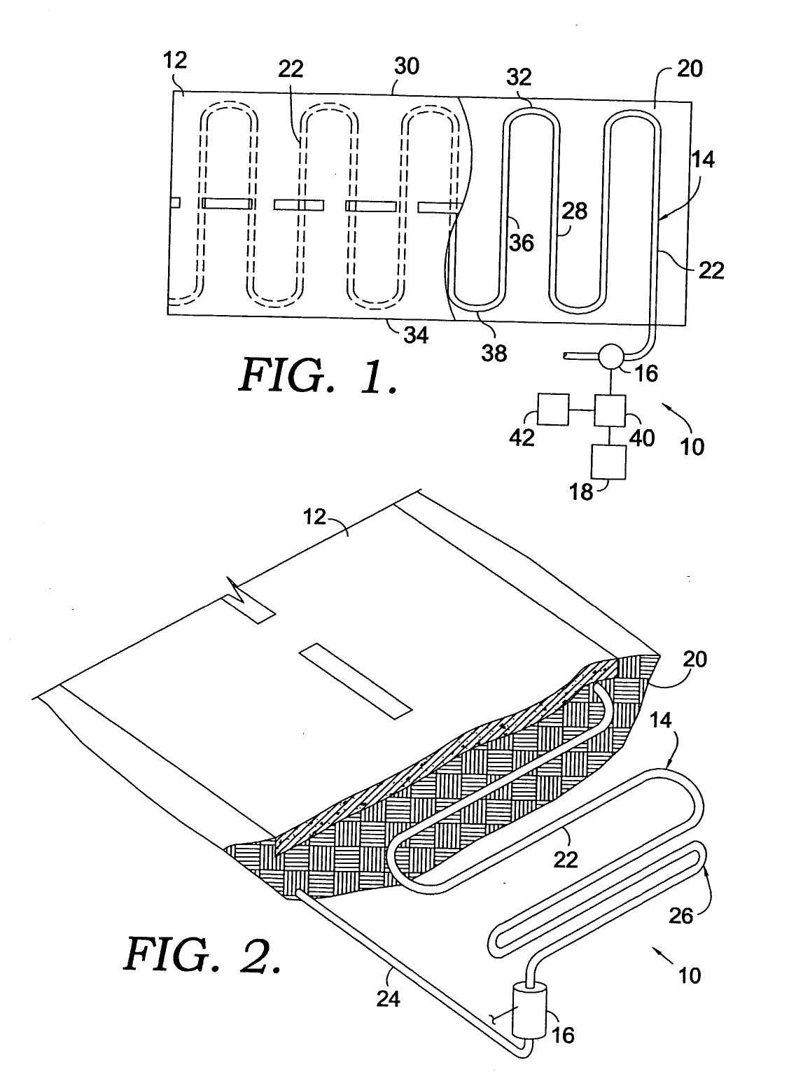

Referring now to the drawings in detail, and initially to FIG. 1, numeral 10 generally designates a heating device constructed in accordance with a first embodiment of the present invention. Heating device 10 is used to melt snow and/or ice that comes into contact with or accumulates on a surface 12. In its most basic configuration, heating device 10 includes a heat coil 14 that allows for the passage of a fluid, a pump 16 and a solar power source 18. Solar power source 18 provides power to pump 16 to move the fluid through heat coil 14. With additional reference to FIG. 2, as the fluid passes through heat coil 14, it takes the natural heat contained underneath the ground 20 and transfers it to surface 12 to melt the ice and/or snow thereon. Although the accompanying drawings illustrate heating device 10 used in conjunction with a road surface 12, it will be understood and appreciated that surface 12 may be a driveway, sidewalk, parking lot or any other surface in which snow and/or ice may come into contact with or accumulate on the surface without departing from the scope of the present invention.

As best seen in FIGS. 1 and 2, heat coil 14 is a tube or pipe that is generally positioned underneath surface 12 and is adapted to allow a fluid to pass therethrough. The fluid contained within heat coil 14 is preferably glycol, but it should be understood that other types of fluid such as water may also be used without departing from the scope of this invention. Antifreeze may also be combined with the fluid to prevent the fluid from freezing and restricting the fluid flow within heat coil 14.

Heat coil 14 includes an upper portion 22, lower portion 24 and a intermediate portion 26 that couples upper and lower portions 22, 24 with one another. In particular, upper portion 22 may be positioned in close proximity to surface 12 so that heat transfer may occur between the fluid contained in upper portion 22 and surface 12. In some instances, upper portion 22 may come in contact with or be embedded within surface 12. With specific reference to FIG. 1, upper portion 22 follows an S-type pattern to obtain adequate coverage to melt the ice/snow on surface 12. Specifically, as best seen in FIG. 1, upper portion 22 extends toward edge 30 in a direction transverse to the longitudinal axis of surface 12 to form a linear portion 28. At that point, upper portion 22 turns approximately 180 degrees as it approaches an edge 30 of surface 12 to form a bend 32. Upper portion 22 proceeds to extend in a direction transverse to the longitudinal axis of surface 12 toward an opposite edge 34 of surface 12 to form another linear portion 36. As linear portion 36 approaches edge 30, it turns 180 degrees to form another bend 38. Linear portions 28, 36 of heat coil 14 may be positioned at various distances from one another, but are preferably spaced about 5 to 6 feet apart. It will be understood and appreciated that the pattern in which upper portion 22 is arranged underneath surface 12 may be diagonal, spiral, grid-like or any other type of pattern that will allow adequate heat transfer between upper portion 22 and surface 12 to melt snow and/or ice on surface 12.

As best seen in FIG. 2, intermediate portion 26 couples upper portion 22 to lower portion 24. In particular, intermediate portion 26 may extend downwardly into the ground from upper portion 22 to lower portion 24 in an S-type pattern, similar to arrangement of upper portion 22 as discussed above. In the alternative, intermediate portion 26 may also be directed vertically downward, or at one or more angles, as it extends toward lower portion 24. Intermediate portion 26 may extend into the ground to a depth where the fluid contained within lower portion 24 will gain the amount of heat necessary to melt the snow and/or ice on surface 12. Intermediate portion 26 may also be used to couple upper and lower portions 22, 24 at the opposite end of heating system 10 located at a distance down the road, which is not shown in the drawings.

Lower portion 24 is coupled to intermediate portion 26 and generally extends in a linear path underneath the ground 20. Specifically, lower portion 24 is positioned in the ground 20 at a depth that will allow the fluid contained within lower portion 24 to gain the natural heat from within ground 20 that is necessary to melt the snow and/or ice on surface 12 when it is eventually moved to upper portion 22. Lower portion 24 may be buried about 3 feet below upper surface 12, or at depths between the range of 1 to 4 feet beneath the ground. However, lower portion 24 is preferably positioned about 3 to 6 feet underneath the ground. Although lower portion 24 is shown in FIG. 2 as extending in a linear path underneath ground 20, it is within the scope of this invention to arrange lower portion 24 in a spiral, diagonal, S-type configuration or any other pattern that will allow an adequate amount of heat exchange to occur between the fluid in lower portion 24 and ground 20. Furthermore, the depth of lower portion 24 need not be constant, but instead could be positioned at various depths within ground 20. Furthermore, it is within the scope of this invention to not include intermediate portion 26 and directly couple upper and lower portions 22, 24 with one another.

As best seen in FIGS. 1 and 2, pump 16 is coupled with heat coil 14 and is used to move the fluid through upper, lower and intermediate portions 22, 24, 26 of heat coil 14. Any type of pump known in the art such as, but not limited to, hydraulic and pneumatic pumps, may be used to move the fluid within heat coil 14. As best seen in FIG. 1, pump 16 is further coupled to a control panel 40. Control panel 40 allows pump 16 to be turned on or off, and may vary the amount of energy that is transferred to pump 16. The amount of power that is transferred to pump 16 generally relates to the rate at which pump 16 moves the fluid through upper, lower and intermediate portions 22, 24, 26 of heat coil 14.

As best seen in FIG. 1, solar power source 18 is coupled with control panel 40 and provides the necessary energy to operate pump 16. Solar power source 18 may include a series of photoelectric cells that are used to convert solar energy into electrical energy. The photoelectric cells may be grouped together to form a solar panel. Further, one or more solar panels may be mounted on a tower, house or other structure to expose the photoelectric cells to solar energy.

Power storage unit 42 is coupled to control panel 40 and provides a location where energy may be stored. Specifically, power storage unit 42 is used to store excess energy collected by solar power source 18 when pump 16 is not in operation, or when solar power source 18 is generating more electrical energy than is required to operate pump 16. Power storage unit 42 may include one or more types of batteries or other types of electrical storage devices. The energy stored by power storage unit 42 may be the sole source of energy for operating pump 16, or may be used in conjunction with the energy collected by solar power source 18, to provide energy to pump 16 to move the fluid through heat coil 14.

In use, the solar panels are used to collect solar energy. The solar energy collected by the photoelectric cells is converted to electrical energy and transferred to control panel 40. When pump 16 is turned in the off position on control panel 40, the electrical energy transferred from solar power source 18 may be directed to power storage unit 42. The electrical energy transferred from solar power source 18 may be used to charge the batteries in the storage unit 42. When pump 16 is turned to the on position, electrical energy transferred from solar power source 18 and/or power storage unit 42 is directed to pump 16 to move the fluid through heat coil 14. As the fluid moves through lower portion 24 of heat coil 14, the fluid absorbs the natural heat contained within the ground 20 thereby increasing the temperature of the fluid. The heated fluid is then moved through intermediate portion 26 and into upper portion 22 of heat coil 14. As the fluid moves through upper portion 22 of heat coil 14, the heat contained within the fluid is transferred to surface 12 and is used to increase the temperature of surface 12. The increase in surface temperature results in the melting of snow and/or ice that is in contact with the surface. After the fluid has finished moving through the upper portion 22, it then moves through the intermediate portion at the opposite end of heat coil 14 and recycles through the lower portion 24. This process repeats until pump 16 is turned to the off position. As a result of the heat transfer from the fluid to surface 12, the temperature of the fluid will decrease. In order to prevent the fluid from freezing and blocking the flow of fluid through heat coil 14, antifreeze may be mixed with the fluid before, during or after operation of heating device 10.

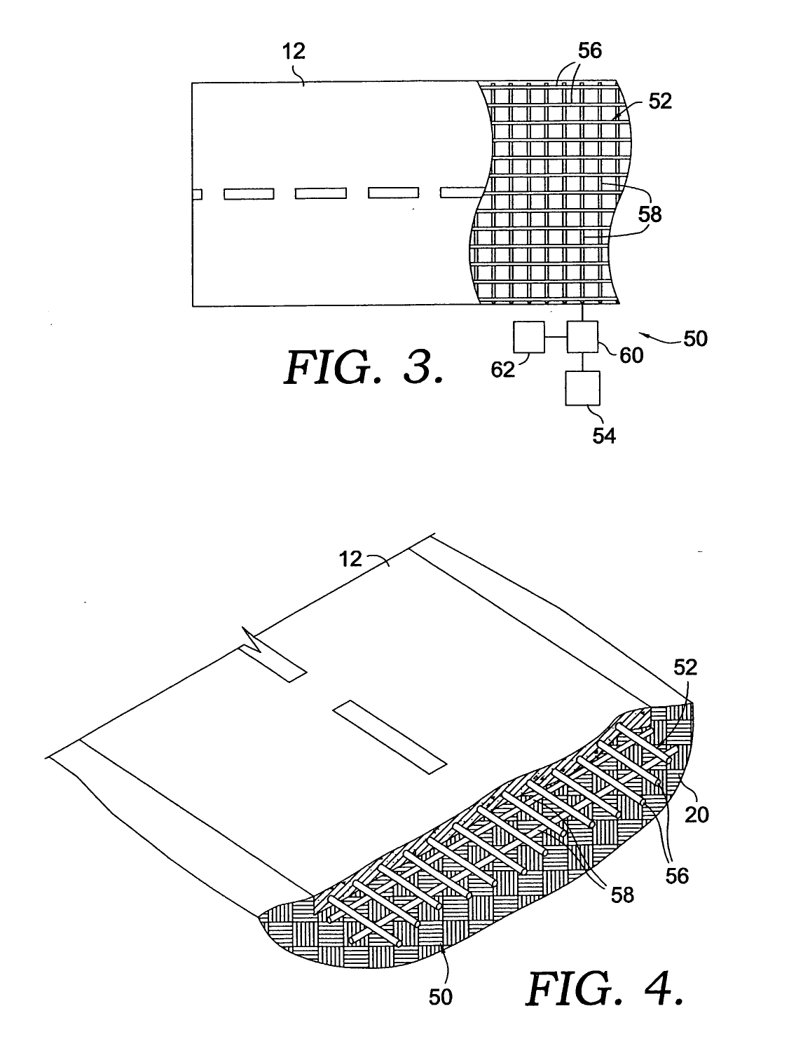

As seen in FIG. 3, another heating device is also within the scope of this invention and is generally referred to as numeral 50. In its most basic configuration, heating device 50 includes a heating element 52 and a solar power source 54. With additional reference to FIG. 4, the electrical energy produced by solar power source 54 is used to increase the temperature of heating element 52. The heat from heating element 52 is then used to melt the ice and/or snow on surface 12.

Heating element 52 is positioned underneath surface 12 and includes a plurality of longitudinal and transverse members 56,58 that are arranged in a grid-like configuration. However, the heating element may be arranged in other configurations such as, but not limited to, diagonal, S-type or spiral configurations. Heating element 52 is formed of an electrically conductive material that will increase in temperature as electric current passes therethrough. Although heating element 52 is shown to be embedded within surface 12, it is also within the scope of this invention to position heating element 52 below surface 12 and into ground 20. In either case, heating element 52 is preferably positioned about 3 inches below the top of surface 12.

Heating element 52 is further coupled with a control panel 60. Control panel 60 used in heating device 50 is coupled to heating element 52 without being coupled to a pump as shown and described in heating device 10. Otherwise, control panel 60 is substantially similar to control panel 40 as described above, therefore it will not be described any further. Control panel 60 is further coupled to a power storage unit 62 and solar power source 54. Again, power storage unit 62 and solar power source 54 are similar to those used in heating device 10 and will not be described in any further detail.

In use, as with the previous embodiment, solar energy is collected by the photoelectric cells and converted to electrical energy. The electric energy is then transferred to control panel 60. When heating element 52 is turned to the off position on control panel 60, the electrical energy transferred from solar power source 54 may be used to charge one or more batteries in power storage unit 62. When heating element 52 is turned to the on position, electrical energy is transferred from solar power source 54 and/or power storage unit 62 and is directed to heating element 52. The electrical energy flows through heating element 52 and the resistance causes it to increase in temperature. The heat generated by heating element 52 is used to increase the temperature of surface 12. The increase in surface temperature causes the snow and/or ice located on surface 12 to melt. This process continues until heating element 52 is turned to the off position and the heating element decreases in temperature.

It can, therefore, be seen that the invention is one that is designed to overcome the drawbacks and deficiencies existing in the prior art. The invention provides a heating device that uses solar energy to melt snow and/or ice that is located on a surface. The present invention also provides a heating device that utilizes the natural heat from the earth to melt the snow and/or ice on a surface. The present invention is time and cost-efficient, requires less manpower and equipment and does not significantly affect the environment compared to conventional methods of snow and ice removal.

While particular embodiments of the invention have been shown, it will be understood, of course, that the invention is not limited thereto, since modifications may be made by those skilled in the art, particularly in light of the foregoing teachings. Reasonable variation and modification are possible within the scope of the foregoing disclosure of the invention without departing from the spirit of the invention.

What is claimed is:

1. A device for reducing the amount of ice and/or snow accumulation on a surface, said device comprising:
a heat coil having an upper portion and a lower portion, said upper portion being positioned at a first distance below the surface, and said lower portion being positioned at a second distance below the surface and underneath the ground, wherein said second distance is greater than said first distance, and wherein said heat coil allows a fluid to pass therethrough;
a pump coupled to said heat coil; and
a solar power source coupled to said pump, said solar power source providing energy to said pump to move the fluid between said lower and upper portions of said heat coil, wherein the fluid gains heat from the ground as it moves through said lower portion of said heat coil and uses that heat to raise the temperature of the surface as the fluid moves through said upper portion of said heat coil thereby melting the snow and/or ice on the surface.

2. The device of claim 1, further comprising a control panel coupled to said pump.

3. The device of claim 2, further comprising a power storage unit coupled with said control panel to store energy collected by said solar power source.

4. The device of claim 3, wherein said power storage unit includes at least one battery.

5. The device of claim 1, wherein the fluid contains antifreeze.

6. The device of claim 1, wherein said heat coil is formed of polyvinylchloride.

7. The device of claim 1, wherein said lower portion is positioned about 1 to 4 feet underneath the ground.

8. A method for reducing snow and/or ice accumulation on a surface, said method comprising:
providing a heat coil having upper and lower portions, said upper portion positioned at a first distance below the surface, said lower portion positioned at a second distance below the surface and underneath the ground, said second distance is greater than said first distance, said heat coil allowing a fluid to pass therethrough;
providing a pump for moving the fluid between upper and lower portions;
providing a solar power source;
heating the fluid in said lower portion;
powering said pump with said solar power source; and
moving the fluid from said lower portion to said upper portion using said pump, wherein the heat in the fluid is transferred to the surface to melt the snow and/or ice thereon.

9. The method of claim 8, further including:
providing a power storage unit; and
storing the energy collected by said solar power source in said power storage unit.

10. The method of claim 8, further comprising controlling the movement of the fluid between said lower and upper portions of said heat coil.

11. The method of claim 8, wherein said lower portion of said heat coil is positioned about 1 to 4 feet underneath the ground.

12. A device for reducing the amount of ice and/or snow accumulation on a surface, said device comprising:
means for collecting solar energy; and
means for transferring the heat from underneath the ground to the surface of the ground using said solar energy, wherein said heat is used to melt the snow and/or ice located on the surface.

13. The device of claim 12, further comprising means for storing said solar energy.

14. The device of claim 12, further comprising means for controlling the amount of said heat that is transferred from underneath the ground to the surface.

15. A device for reducing the amount of ice and/or snow accumulation on a surface, said device comprising:
a heating element positioned below the surface; and
a solar power source coupled to said heating element, wherein said solar power source provides power to said heating element to increase the temperature of said heating element, and wherein said heat from said heating element is transferred to the surface to melt the snow and/or ice on the surface.

16. The device of claim 15, wherein said heating element is positioned about 3 inches below the surface.

17. The device of claim 15, wherein said heating element is a grid.

18. The device of claim 15, further comprising a control panel coupled between said solar power source and said heating element.

19. The device of claim 18, further comprising a power storage unit coupled with said control panel to store energy collected by said solar power source.

20. The device of claim 19, wherein said power storage unit includes at least one battery.

21. A device for reducing the amount of ice and/or snow accumulation on a surface, said device comprising:
a heating element;
means for collecting solar energy; and
means for transferring the solar energy to said heating element to increase the temperature of said heating element, wherein said heat from said heating element is transferred to the surface to melt the snow and/or ice thereon.

22. The device of claim 21, further comprising means for storing said solar energy.

23. The device of claim 21, further comprising means for controlling the amount of energy that is transferred to said heating element.

24. The device of claim 21, wherein said heating element is a grid.

25. A method for reducing snow and/or ice accumulation on a surface, said method comprising:
providing a heating element positioned at a distance below the surface;
providing a solar power source;
transferring energy from said solar power source to said heating element; and
heating said heating element, wherein the heat from said heating element is transferred to the surface to melt the snow and/or ice accumulation on the surface.

26. The method of claim 25, further including:
providing a power storage unit; and
storing the energy collected by said solar power source in said power storage unit.

27. The method of claim 25, further comprising controlling the amount of energy transferred to said heating element.

28. The method of claim 25, wherein said heating element is positioned about 3 inches below the surface.
